(19) United States
(12) Patent Application Publication
(10) Pub. No.: US 2012/0194856 A1
(43) Pub. Date: Aug. 2, 2012

(54) FACSIMILE COMMUNICATION APPARATUS AND CONTROL METHOD THEREOF

(75) Inventor: Shigeru Koizumi, Tokyo (JP)

(73) Assignee: Canon Kabushiki Kaisha, Tokyo (JP)

(21) Appl. No.: 13/256,508

(22) PCT Filed: Jul. 4, 2011
(86) PCT No.: PCT/JP2011/065741

§ 371 Date: Sep. 14, 2011

(30) Foreign Application Priority Data
Aug. 26, 2010 (JP) 2010-189989

(51) Int. Cl. G06F 3/12

(52) U.S. Cl. 358/1.15

(57) ABSTRACT

A facsimile communication apparatus for transmitting and receiving image data via a telephone public circuit network is provided. The apparatus includes a first detection unit configured to detect a call signal from the network; a line capturing unit configured to capture the network in response to the detection of the call signal; a second detection unit configured to detect that a voltage value applied from the network has exceeded a threshold after the capture of the network; a protection unit configured to execute a protection function of protecting the apparatus from a voltage applied from the network in response to the detection of an exceeded voltage value; and a control unit configured to control the protection unit to switch from an ON state to an OFF state, after the capture of the network and before reception of image data.

### TECHNICAL FIELD

The present invention relates to a facsimile communication apparatus and a method of controlling the facsimile communication apparatus.

### BACKGROUND ART

Some recent facsimile communication apparatuses include a communication modem, a semiconductor data access arrangement (to be referred to as a DAA hereinafter) for interfacing with telephone lines, a call signal detection circuit which detects a call signal, an off-hook detection circuit which detects an off-hook event, and a discrete component for protection against noise. A DAA functions as an NCU (Network Control Unit) and is formed from a semiconductor IC. For this reason, a DAA is also called an SDAA (Silicon DAA). The discrete component is a component provided near the DAA. As this component, one that recommended by the manufacturer is used. The following description is based on the assumption that the discrete component is incorporated in the DAA. Such a facsimile communication apparatus makes settings complying with the specifications in each country (for example, a country code) in the modem and the DAA. Operation corresponding to the settings allows the apparatus to be compatible with the specification in each country. The facsimile communication apparatus incorporating the DAA captures (off-hooks) a line in response to a call signal over a public circuit. However, when a switching equipment which transmits call signals delays in detecting a DC loop, the system keeps transmitting a call signal even after the DAA captures a line. This may damage an electric circuit forming the DAA.

There is available a technique (overcurrent protection function) of solving this problem by detecting a current corresponding to a voltage applied from a line and performing control to reduce a current flowing in the DAA if the detected current value is equal to or more than a predetermined value. For example, Japanese Patent Laid-Open No. 11-168572 discloses a technique of protecting an internal circuit from damage by detecting an abnormal current in a modem circuit and forcibly opening the closed circuit. This technique is designed to prevent, for example, an internal circuit in a button telephone from being destroyed when the modular jack of a communication apparatus is erroneously inserted into the modular port of a button telephone.

### SUMMARY OF INVENTION

The overcurrent protection function also detects a current which flows in the DAA when accidentally occurring surge noise is applied to the DAA, in addition to a current which flows in the DAA when a call signal is applied to the DAA, and protects the DAA. This poses the following problem. When, for example, surge noise such as lightning noise is applied to a communication line during communication of image data, detecting the surge noise will set an on-hook state. This brings about a state like a line hit. Upon detecting this state, the switching equipment disconnects the line. As a consequence, it may be impossible to comply with communication specifications that require to continue communication without disconnecting a line against surge noise such as lightning noise.

The protection of a circuit against surge noise such as lightning noise will be described with reference to the arrangement of the communication unit in FIG. 2. A communication unit 14 protects the circuit by including an arrestor element 9 provided between a telephone public circuit network 4 and GND and a varistor element 7 provided between circuits. When communication data is destroyed due to the application of surge noise such as lightning noise to a communication line during the communication of image data, the image data is recovered by retransmission. This normally terminates the image communication. That is, this prevents the interruption of the communication and hence prevents the occurrence of a communication error. When, however, surge noise such as lightning noise is applied to the circuit during the communication of image data while the overcurrent protection function is effective, the overcurrent protection function is activated to perform control to set a high DC resistance at the time of capturing a line, a state like a line hit is set. This causes the switching equipment to disconnect the line and hence may cause a communication error.

The present invention has been made in consideration of the above problem, and prevents the disconnection of a line by an overcurrent protection function due to the accidental application of surge noise during the communication of image data, while preventing circuit damage due to the application of a call signal, by controlling the operation period of the overcurrent protection function.

A first aspect of the present invention provides a facsimile communication apparatus for transmitting and receiving image data via a telephone public circuit network, comprising: first detection means configured to detect a call signal from the telephone public circuit network; line capturing means configured to capture the telephone public circuit network in response to that the first detection means has detected the call signal; second detection means configured to detect that a voltage value applied from the telephone public circuit network has exceeded a predetermined threshold after the line capturing means has captured the telephone public circuit network; protection means configured to execute a protection function of protecting the facsimile communication apparatus from a voltage applied from the telephone public circuit network in response to that the second detection means has detected that a voltage value applied from the telephone public circuit network has exceeded the predetermined threshold; and control means configured to control the protection means to switch from an ON state in which the protection function is executed to an OFF state in which the protection function is not executed, after the line capturing means captures the telephone public circuit network and before image data is received from another facsimile communication apparatus which has generated the call signal.

A second aspect of the present invention provides a method of controlling a facsimile communication apparatus for transmitting and receiving image data via a telephone public circuit network, the method comprising: detecting, by first detection means of the facsimile communication apparatus, a call signal from the telephone public circuit network; capturing, by line capturing means of the facsimile communication apparatus, the telephone public circuit network in response to that the first detection means has detected the call signal; detecting, by second detection means of the facsimile communication apparatus, that a voltage value applied from the telephone public circuit network has exceeded a predetermined threshold after the line capturing means has captured the telephone public circuit network; executing, by protection means of the facsimile communication apparatus, a protection function of protecting the facsimile communication apparatus from a voltage applied from the telephone public circuit network in response to that the second detection means has detected that a voltage value applied from the telephone public circuit network has exceeded the predetermined threshold; and controlling, by control means of the facsimile communication apparatus, the protection means to switch from an ON state in which the protection function is executed to an OFF state in which the protection function is not executed, after the line capturing means captures the telephone public circuit network and before image data is received from another facsimile communication apparatus which has generated the call signal.

Further features of the present invention will become apparent from the following description of exemplary embodiments (with reference to the attached drawings).

### BRIEF DESCRIPTION OF DRAWINGS

The accompanying drawings, which are incorporated in and constitute a part of the specification, illustrate embodiments of the invention, and together with the description, serve to explain the principles of the invention.

FIG. 1 is a block diagram showing the overall arrangement of an exemplary communication apparatus according to an embodiment of the present invention;

FIG. 2 is a block diagram showing the detailed arrangement of an exemplary communication unit;

FIG. 3 is a view showing the concept of an exemplary residual call signal;

FIG. 4 is an exemplary view showing the influence of surge noise on an overcurrent protection function;

FIG. 5 is a flowchart showing exemplary operation at the time of reception of image data;

FIG. 6 is a flowchart showing exemplary operation at the time of transmission of image data; and

FIG. 7 is a chart showing the waveform of an exemplary call signal.

### DESCRIPTION OF EMBODIMENTS

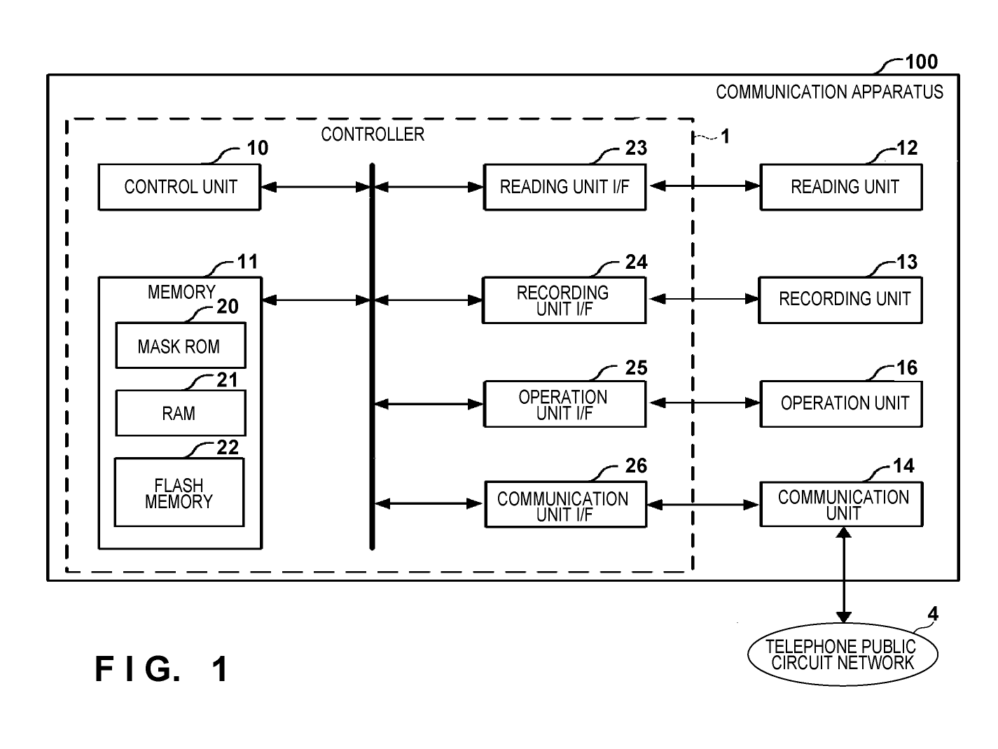

The embodiments of the present invention will be described in detail below with reference to the accompanying drawings. Note however that the following embodiments do not limit the scope of the present invention. In addition, not all combinations of the features described in the embodiments are necessarily essential to the means of solving provided by the present invention.

[Overall Arrangement (FIG. 1)]

A communication apparatus 100 according to an embodiment of the present invention is assumed to be a facsimile communication apparatus for transmitting and receiving image data via a telephone public circuit network. The communication apparatus 100 includes a controller 1, a reading unit 12, a recording unit 13, an operation unit 16, and a communication unit 14. The controller 1 includes a control unit 10, a memory 11, and various types of interfaces. The control unit 10 is, for example, a system control LSI or CPU, which controls the overall apparatus in accordance with the programs stored in a mask ROM 20 included in the memory 11 (to be described later). The memory 11 includes the mask ROM 20, a flash memory 22, and a RAM 21. The mask ROM 20 and the flash memory 22 are nonvolatile memories which can hold data even in a state in which the power supply of the apparatus is shut off. The mask ROM 20 stores a boot program and main program in a compressed state, which are used to control the system. The flash memory 22 stores, for example, the name and dial information of each communication destination or communication results and the like. The RAM 21 is a volatile memory which cannot hold data while the power supply of the apparatus is shut off. The RAM 21 is, for example, a DRAM (or SRAM), which stores various kinds of data and also functions as an area for the execution of each kind of program. The control unit 10 expands and executes, in the RAM 21, the main program compressed and stored in the mask ROM 20, at the time of startup of the apparatus.

The reading unit 12 is connected to a reading unit I/F 23. The reading unit 12 performs image processing of data read by using a CCD or CMOS line sensor (not shown) and stores the data in the RAM 21 or the flash memory 22 under the control of the control unit 10. The recording unit 13 is connected to a recording unit I/F 24. The recording unit 13 is, for example, a laser beam printer. The control unit 10 extracts recorded data stored in the RAM 21 or the flash memory 22, and sends the data to the recording unit 13, thereby printing out the data as a hard copy. The operation unit 16 is connected to an operation unit I/F 25, and includes a display unit which displays information which makes the user designate each kind of operation mode and a switch by which the user designates each kind of operation mode by referring to information displayed on the display unit. The communication unit 14 is connected to a communication unit I/F 26. The communication unit 14 is also connected to the telephone public circuit network 4. The detailed arrangement of the communication unit 14 will be described later.

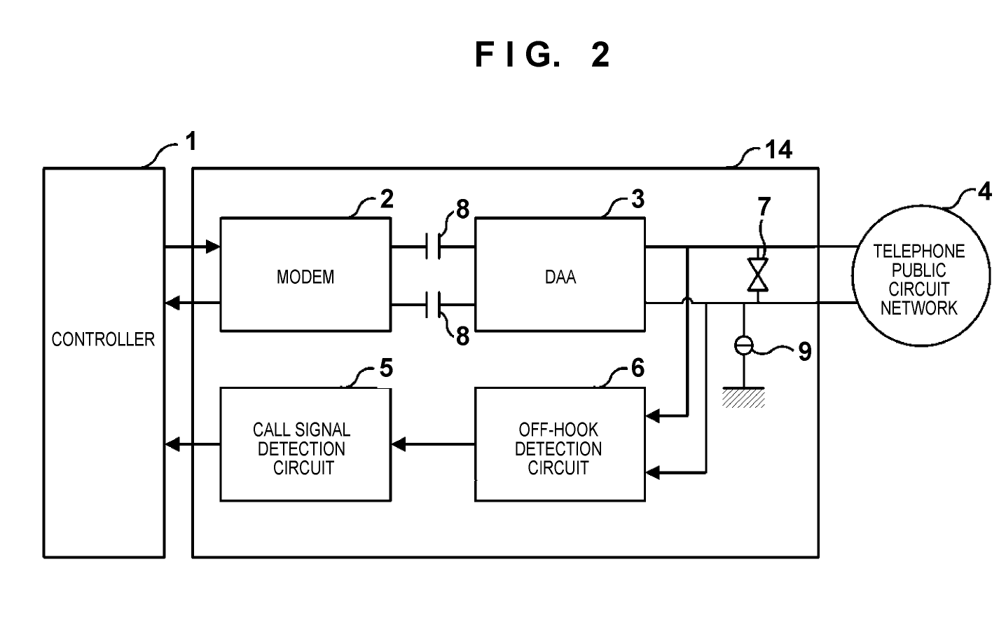

The communication apparatus 100 can be applied to all types of communication apparatuses having a facsimile communication function. PTT specifications associated with facsimile communication change for each country, in particular, and hence the present invention is applied to communication apparatuses complying with such specifications in each country.

[Detailed Arrangement of Communication Unit (FIG. 2)]

The communication unit 14 includes a modem 2, a semiconductor DAA 3 (second detection unit), a call signal detection circuit 5 (first detection unit), an off-hook detection circuit 6, and a discrete component for line control. The communication unit 14 has a varistor 7 mounted between lines and an arrestor 9 mounted between a line and GND to prevent circuit damage due to surge noise such as lightning noise. The varistor 7 and the arrestor 9 prevent circuit damage which occurs when surge noise such as lightning noise is applied to a line in the normal mode or the common mode.

The modem 2 includes a G3 modem which matches ITUT recommendations and a clock generation circuit connected to the modem. The modem 2 modulates the transmission data stored in the RAM 21 or the flash memory 22 under the control of the control unit 10, and outputs the resultant data to the telephone public circuit network 4 via the DAA 3. The modem 2 receives image data by facsimile communication and stores the data in the RAM 21 or the flash memory 22.

The modem 2 includes a DAA interface for connection to the DAA 3 and a serial interface for connected to the controller 1. The modem 2 has a function of modulating and demodulating image data and controlling a communication protocol. The modem 2 has a control system using a command set and is compatible with Super-G3 FAX communication.

The DAA 3 is a semiconductor data access arrangement. The DAA 3 has the following functions: DC termination (line capture), AC termination, detection of the voltage of a call signal, impedance adjustment between lines, and isolation interfacing.

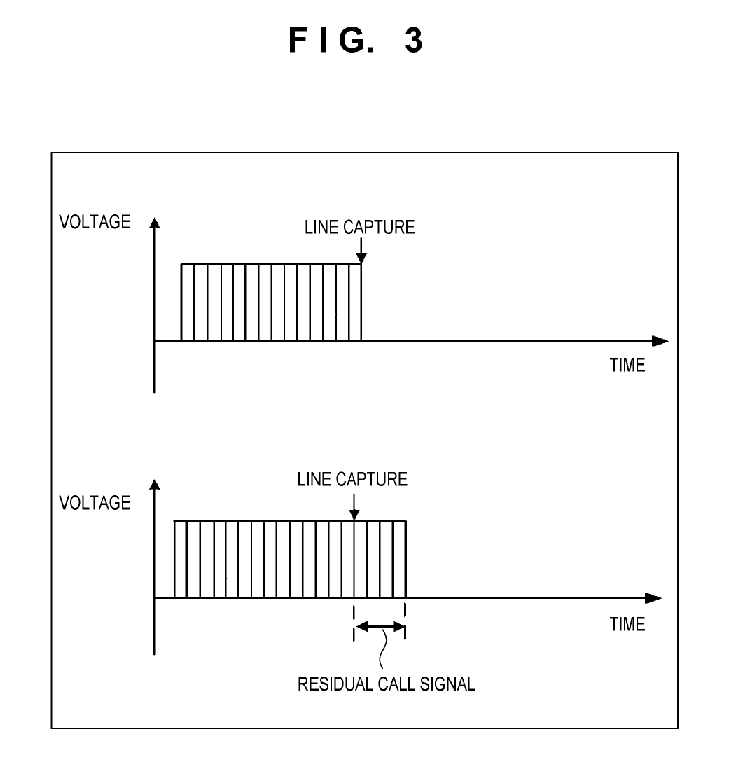

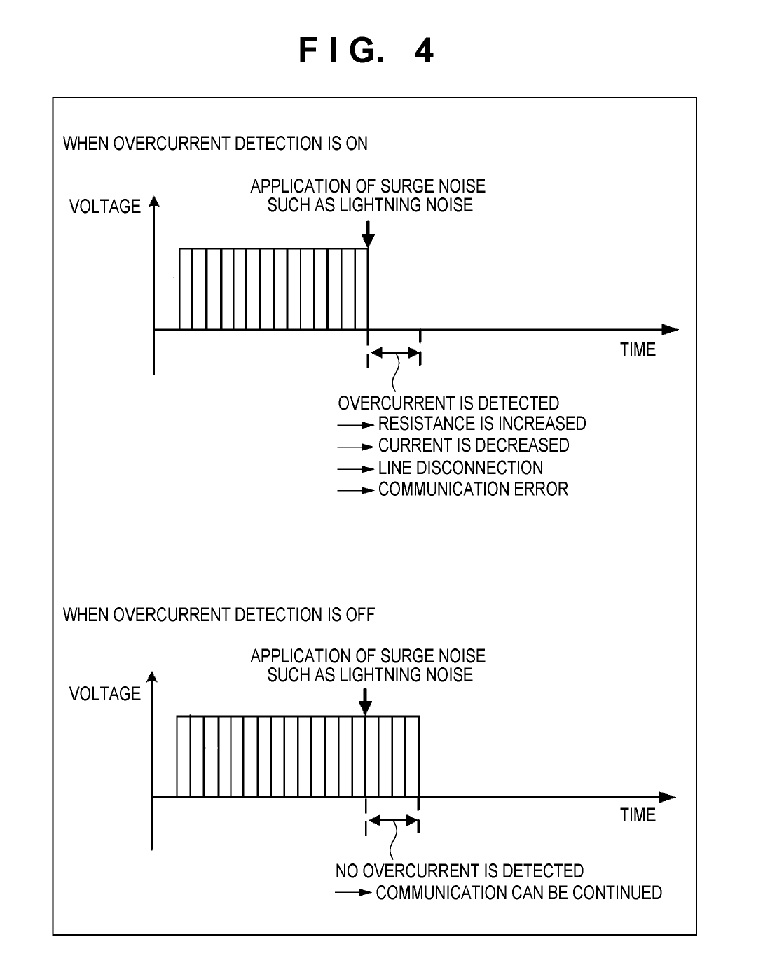

The modem 2 receives the analog signal terminated from the telephone public circuit network 4 via the DAA 3, and demodulates the received analog signal. The controller 1 stores the resultant signal in an image format such as JBIG in the RAM 21 or the flash memory 22. Capacitors 8 are provided between the modem 2 and the DAA 3 to physically isolate the modem 2 from the DAA 3 so as to make the modem 2 and the DAA 3 function as an interface for communication between them.

[Residual Call Signal (FIGS. 3, 4, and 7)]

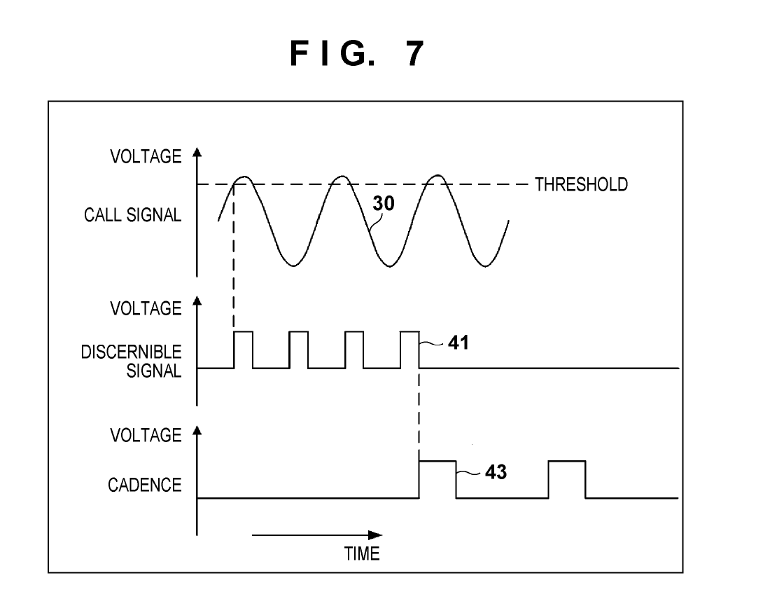

A call signal 30 is a line voltage which changes in a sine wave form at a predetermined period on the telephone public circuit network 4. The switching equipment transmits this signal. For example, a call signal used for a public circuit in Japan is a repetitive signal having a frequency of 16 Hz, a voltage value (effective value) of 75 V (rms), a sine wave as a signal form, and a cadence of one second on and two seconds off. As shown in FIG. 7, the call signal 30 is formed from an intermittent ringing having a predetermined period and a sine wave. The call signal detection circuit 5 detects the call signal 30.

The call signal detection circuit 5 receives the call signal 30 terminated from the telephone public circuit network 4. If the voltage value to be applied is equal to or more than a predetermined threshold, the call signal detection circuit 5 outputs a discernible signal 41 having a square waveform based on an input signal. The discernible signal 41 is sent to the input port of the control unit 10. The control unit 10 measures a cadence 43 of the discernible signal 41 input to the port. In this case, if the call signal 30 is an effective call signal, the control unit 10 controls the DAA 3 to capture the telephone public circuit network 4. Upon detecting a DC loop formed when the communication apparatus 100 captures the telephone public circuit network 4, the switching equipment stops outputting the call signal 30. Depending on the characteristics of a switching equipment in each country, a delay time may occur between the instant the communication apparatus 100 captures a line and the instant the switching equipment stops outputting a call signal. A call signal output from the switching equipment within this delay time is called a residual call signal or a residual CI.

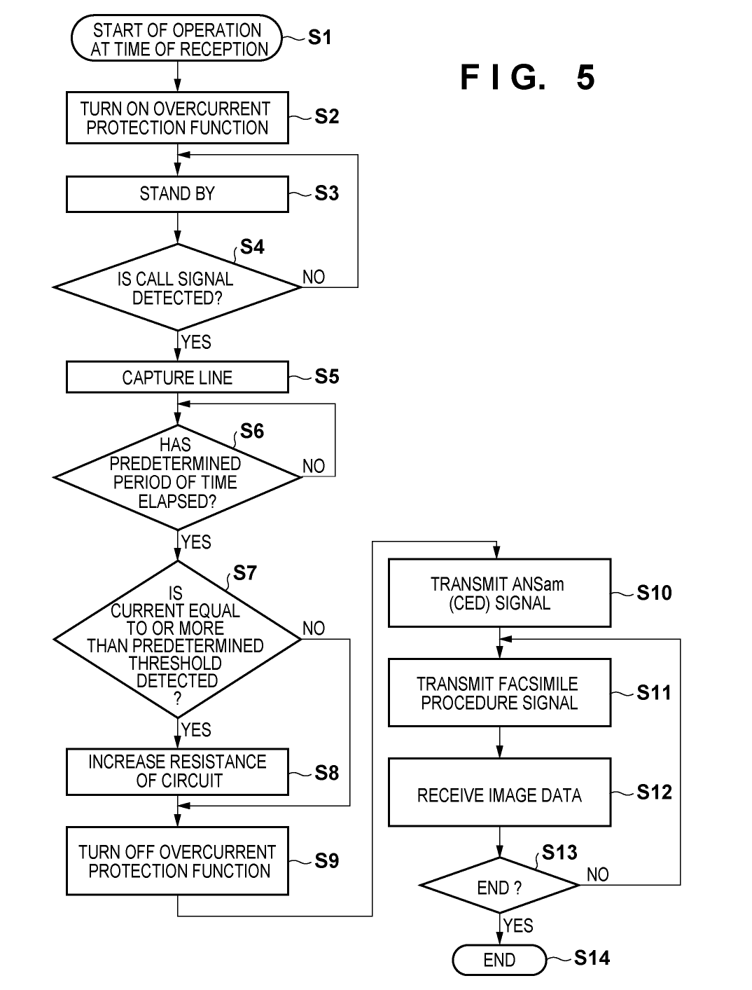

The chip sets of the modem 2 and DAA 3 each have an overcurrent protection function for preventing circuit damage by a residual call signal at the time of line capture. The overcurrent protection function detects a current which is generated when a high-voltage signal is applied to a line during line capture (communication), and performs control to increase a DC resistance at the time of line capture by the DAA 3 (control unit) if the current value of the current is equal to or more than a predetermined threshold, thereby preventing circuit damage. As shown on the lower side in FIG. 3, even if the telephone public circuit network 4 is captured at the timing of line capture during the termination of the call signal 30, the switching equipment may output a residual call signal for several 100 msec. In this case, since a high-voltage residual call signal is applied to the DAA 3 and a circuit accompanying the DAA 3, these circuits may be damaged. It is thought that a residual call signal is applied for a long period of time and exceeds the current tolerance of a circuit, and hence the circuit is susceptible to damage. On the other hand, it is thought that surge noise due to lightning has a very short noise width (period) (several 100 μsec), and it is easy to protect a circuit because the surge noise is clamped or discharged by using a protection element. If the overcurrent protection function is effective, it is possible to prevent the DAA 3 from circuit damage even at the arrival of a residual call signal. Note, however, that if surge noise with a very high voltage such as lightning noise is applied to the communication line during the communication of image data, the overcurrent protection function is activated to make the DAA 3 perform control to greatly increases the DC resistance at the time of line capture. This greatly reduces the DC current flowing through the line (so as to be approximate to 0 [A]). As a result, the switching equipment regards this state as line disconnection, and disconnects (opens) the line.

[Processing Procedure at Time of Reception of Image Data (FIG. 5)]

An example of the operation timing control of the overcurrent protection function in facsimile communication will be described below. In step S1, when starting a reception sequence, the controller 1 performs command control of the modem 2 by causing the CPU of the control unit 10 to execute operation. The controller 1 further sets the country code of a destination country in the modem 2.

In step S2, the controller 1 turns on the overcurrent protection function to prevent the DAA 3 from circuit damage due to a residual call signal at the time of the termination of a call signal. In step S3, the controller 1 becomes standby after initialization. In step S4, the controller 1 determines whether the call signal detection circuit 5 has detected a call signal.

If the call signal detection circuit 5 has not detected any call signal (NO in step S4), the controller 1 returns to step S3 to wait for a call signal. If the call signal detection circuit 5 has detected a call signal (YES in step S4), the process advances to step S5. In step S5, the controller 1 captures a line in accordance with the DC resistance of the destination code set by the DAA 3. The controller 1 (control unit) then waits for a predetermined period of time for the proper timing of turning off the overcurrent protection function (S6), and determines whether a current equal to or more than a predetermined threshold has been detected (S7).

If a current equal to or more than the predetermined threshold is detected (YES in step S7), the controller 1 performs control to increase the circuit resistance of the DAA 3 (S8), and turns off the overcurrent protection function (S9). The controller 1 performs control to increase the circuit resistance of the DAA 3 in order to decrease the current value of a current flowing in the DAA 3. If no current equal to or more than the predetermined threshold has been detected (NO in step S7), the controller 1 turns off the overcurrent protection function without increasing the circuit resistance of the DAA 3 (S9). Since the overcurrent protection function is kept off from this timing, even if surge noise such as lightning noise is applied to a communication line, no communication error due to line release by the switching equipment occurs. Assume that the time from the instant the overcurrent protection function is turned off in step S9 to the next step is short.

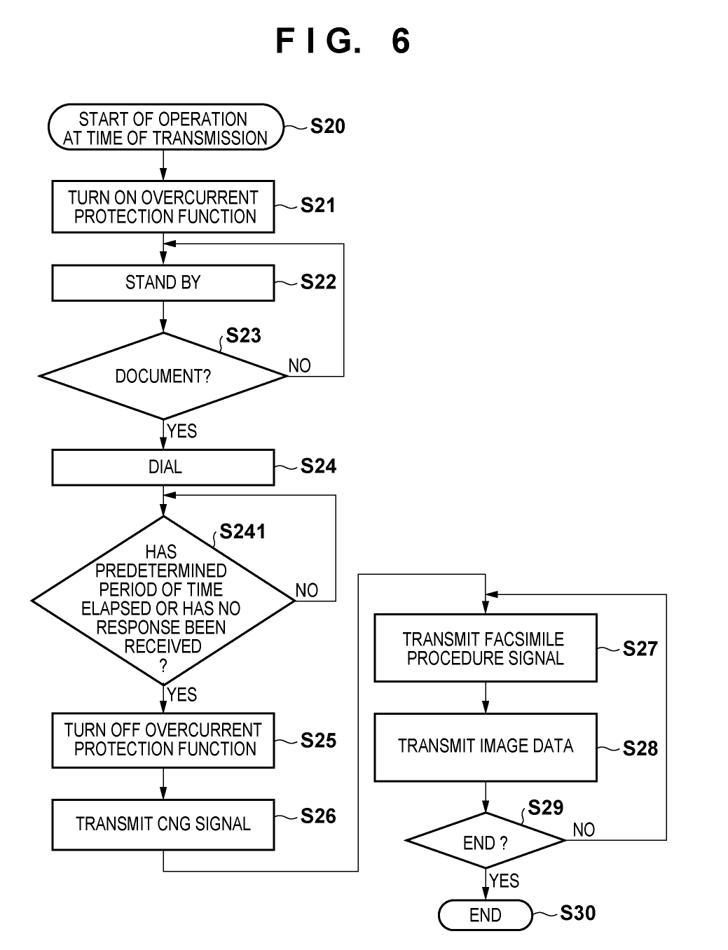

In step S10, the controller 1 transmits an ANSam signal (a response signal to a call signal) indicating that an automatic reception mode is set at the time of the termination of a call signal. The controller 1 transmits a facsimile procedure signal (S11), and receives image data (image signal) (S12). If the communication is not complete (NO in step S13), the process returns to step S11. If the communication is complete in step S13, the controller 1 terminates the series of processing in step S14.

[Processing Procedure at Transmission of Image Data (FIG. 6)]

An example of the operation timing control of the overcurrent protection function in facsimile communication will be described below. In step S20, when starting the transmission sequence, the controller 1 performs command control of the modem 2 by causing the CPU of the control unit 10 to execute operation. The controller 1 further sets the country code of a destination country in the modem 2.

In step S21, the controller 1 turns on the overcurrent protection function to prevent the DAA 3 from circuit damage by a residual call signal which is kept output after the line is captured. In step S22, the controller 1 becomes standby after initialization. In step S23, the controller 1 checks the presence/absence of a document to be transmitted. If there is a document to be transmitted (YES in step S23), the user operates the operation unit 16 to dial to a destination (transmission destination) input in advance (S24).

The controller 1 waits until a predetermined period of time elapses or a response is received from the destination after dialing operation (S241). If the predetermined period of time has elapsed or a response is received from the destination (YES in step S241), the controller 1 turns off the overcurrent protection function (S25).

Since the overcurrent protection function is kept off from this timing, no communication error occurs due to line disconnection caused by the application of surge noise such as lightning noise, even if the modem 2 is under communication. In step S26, therefore, the controller 1 transmits a CNG signal indicating that the automatic transmission mode is set. The controller 1 transmits a facsimile procedure signal (S27), and transmits image data (image signal) (S28). If the communication is not complete in step S29 (NO in step S29), the process returns to step S27. If the communication is complete in step S29 (YES in step S29), the controller 1 terminates the series of processing in step S30.

In the above embodiment, the overcurrent protection function is the function of preventing circuit damage by detecting a current generated when a high-voltage signal is applied to a line during line capture. However, this function may take other forms. For example, this function may be a function of preventing circuit damage by detecting a voltage itself to detect the application of a high-voltage signal to a line during line capture instead of detecting a current. That is, the overcurrent protection function may be a function of preventing circuit damage by detecting that a voltage value applied from a telephone public circuit network after the communication apparatus 100 captures the telephone public circuit network exceeds a predetermined threshold.

In the above embodiment, the overcurrent protection function is configured to be turned off before the transmission of a response signal to a call signal. However, this function may take other forms. Since this apparatus prevents a line from being disconnected by the overcurrent protection function when at least image data is received (step S12 in FIG. 5), the overcurrent protection function may be configured to be turned off before the reception of image data.

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (for example, computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2010-189989, filed Aug. 26, 2010, which is hereby incorporated by reference herein in its entirety.

1. A facsimile communication apparatus for transmitting and receiving image data via a telephone public circuit network, comprising:
a first detection unit configured to detect a call signal from the telephone public circuit network;
a line capturing unit configured to capture the telephone public circuit network in response to that said first detection unit has detected the call signal;
a second detection unit configured to detect that a voltage value applied from the telephone public circuit network has exceeded a predetermined threshold after said line capturing unit has captured the telephone public circuit network;
a protection unit configured to execute a protection function of protecting the facsimile communication apparatus from a voltage applied from the telephone public circuit network in response to that said second detection unit has detected that a voltage value applied from the telephone public circuit network has exceeded the predetermined threshold; and
a control unit configured to control said protection unit to switch to an OFF state in which the protection function is not executed, after said line capturing unit captures the telephone public circuit network and before image data is received from another facsimile communication apparatus which has generated the call signal.

2. The apparatus according to claim 1, wherein said control unit controls said protection unit to switch from an ON state in which the protection function is executed to an OFF state in which the protection function is not executed, after said line capturing unit captures the telephone public circuit network and before a response signal corresponding to the call signal is transmitted.

3. A method of controlling a facsimile communication apparatus for receiving image data via a telephone public circuit network, the method comprising:
detecting, by a first detection unit of the facsimile communication apparatus, a call signal from the telephone public circuit network;
capturing, by a line capturing unit of the facsimile communication apparatus, the telephone public circuit network in response to that the first detection unit has detected the call signal;
detecting, by a second detection unit of the facsimile communication apparatus, that a voltage value applied from the telephone public circuit network has exceeded a predetermined threshold after the line capturing unit has captured the telephone public circuit network;
executing, by a protection unit of the facsimile communication apparatus, a protection function of protecting the facsimile communication apparatus from a voltage applied from the telephone public circuit network in response to that the second detection unit has detected that a voltage value applied from the telephone public circuit network has exceeded the predetermined threshold; and
controlling, by a control unit of the facsimile communication apparatus, the protection unit to switch to an OFF state in which the protection function is not executed, after the line capturing unit captures the telephone public circuit network and before image data is received from another facsimile communication apparatus which has generated the call signal.

4. The method according to claim 3, wherein the control unit controls the protection unit to switch from an ON state in which the protection function is executed to an OFF state in which the protection function is not executed, after the line capturing unit captures the telephone public circuit network and before a response signal corresponding to the call signal is transmitted.
